(19) United States
(12) Patent Application Publication
(10) Pub. No.: US 2005/0081622 A1
(43) Pub. Date: Apr. 21, 2005

(54) System for detecting the positioning of a measuring module on a fluid meter

(76) Inventors: Laurent Demia, (US); Serge Bulteau, (US); Alain Cros, (US); Lue Benoit, (US)

Correspondence Address: SOFER & HAROUN, LLP, Suite 910, 317 Madison Avenue, New York, NY, 10017, US

(21) Appl. No.: 10/744,592

(22) Filed: Dec. 22, 2003

(30) Foreign Application Priority Data
Dec. 23, 2002 (FR) 02 164 89

(51) Int. Cl. G01P 21/00

(52) U.S. Cl. 73/272 A; 73/1.16

(57) ABSTRACT

The present invention relates to a system for detecting the positioning of a remote measuring module (2) placed on a fluid meter (1), a wall (2A) associated with said module being disposed close to a wall (1A) associated with the meter. According to the invention, it comprises at least a first electrically conductive element (10) fixed to said wall (1A) of the meter (1) and at least two second electrically conductive elements (20A, 20B) fixed to said wall (2A) of the module (2), and placed facing the first element (10) when the module is correctly positioned on the meter, the second elements are connected electrically to an electronics card (21), one of the second elements (20A) being a voltage-emitter electrode and the other of the second elements (20B) being a voltage-receiver electrode.

### RELATED APPLICATION

The present invention is related to and claims the benefit of priority from French Patent Application No. 02 16489, filed on Dec. 23, 2002, the entirety of which is incorporated herein by reference.

The invention relates to a system for detecting the positioning of a measuring module on a fluid meter, in particular a water meter.

It is known to associate a fluid meter with a measuring module disposed on the meter for the purpose of enabling the consumption of the meter to be read remotely. By way of example, the measurement can be performed optically, capacitatively, magnetically, or inductively. In general, the meter has a visible consumption indicator in the form of a rotary indicator disk whose rotation is detected by the module, and the signal received by the module is processed in order to determine the number of revolutions performed by the disk, and possibly also its direction of rotation.

In order to enable such detection to take place properly, the module must be correctly positioned on the face of the meter in which the disk is located, so that the detection means of the module are generally placed facing the disk or at least in a position relative to the disk that is precise.

Furthermore, it is important to detect any fraudulent removal or lifting of the module.

It is also known to make such a detection system by means of a mechanical element of the pushbutton type.

Such a system is difficult to adjust concerning its detection stroke, requires a special sealing arrangement, and it is relatively complex and expensive to manufacture.

The invention solves these technical problems by proposing a system for detecting position that is reliable and compact.

To do this, the invention provides a system for detecting the positioning of a remote measuring module placed on a fluid meter, a wall associated with said module being disposed close to a wall associated with the meter, the system being characterized in that it comprises at least a first electrically conductive element fixed to said wall of the meter and at least two second electrically conductive elements fixed to said wall of the module, and placed facing the first element when the module is correctly positioned on the meter, the second elements are connected electrically to an electronics card, one of the second elements being a voltage-emitter electrode and the other of the second elements being a voltage-receiver electrode.

In a first preferred embodiment, the first element is fixed on said wall of the meter on the inside thereof.

In a second preferred embodiment, the meter includes a moving consumption indicator, and the first element is fixed on the face of said indicator that faces towards the module.

Advantageously, the second elements are integrated in said electronics card.

The electrically conductive elements may be metal coatings or stick-on labels.

Preferably, the system includes an alarm put into operation in the event of any change in the capacitance of the capacitor formed by said electrically conductive elements.

The alarm may be put into operation when the capacitance departs from a threshold value, and it may activate a light signal.

The invention also provides a fluid meter including a first electrically conductive element forming a portion of a system for detecting positioning as specified above.

Finally, the invention provides a detection module for co-operating with a fluid meter and comprising second electrically conductive elements forming a portion of a system for detecting positioning as specified above.

The invention is described below in greater detail with reference to figures that show some preferred embodiments of the invention.

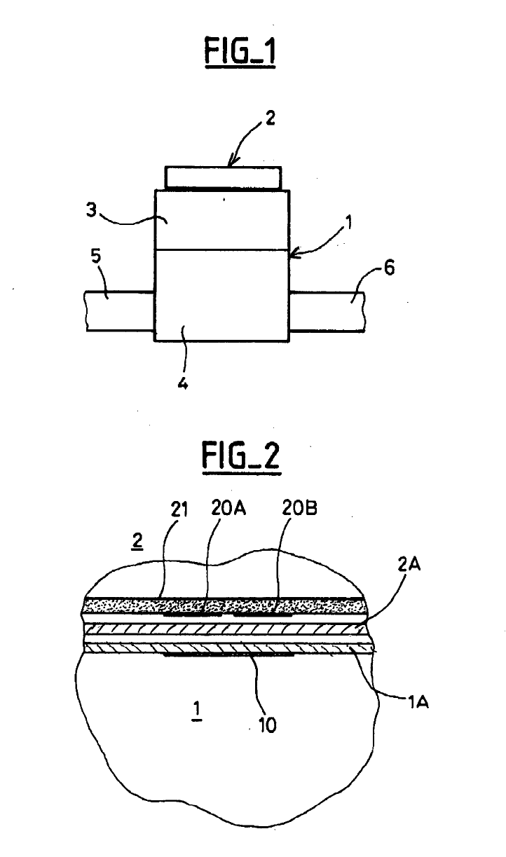

FIG. 1 is a front view of a meter and a measurement module in accordance with the invention.

FIG. 2 is a section view of a system for detecting positioning and comprising a first embodiment of the invention.

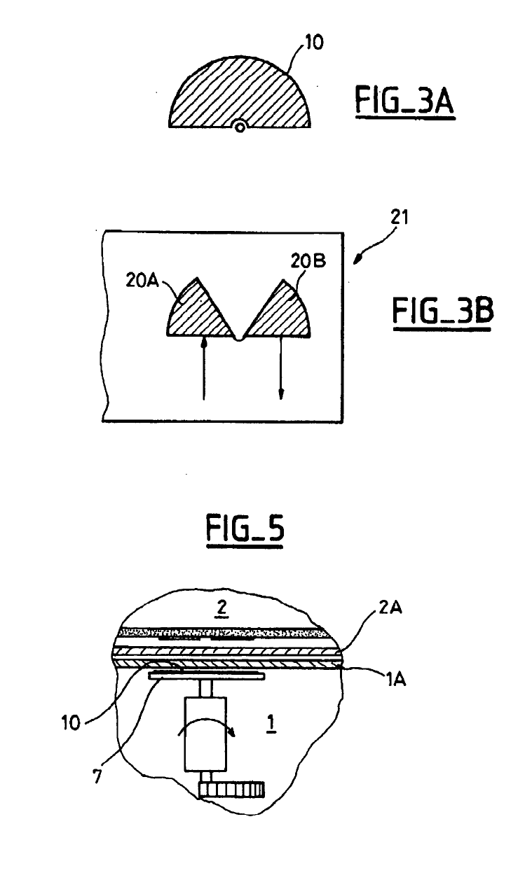

FIGS. 3A and 3B are a front view of a portion of the detection system and a front view of another portion of the detection system in a first embodiment.

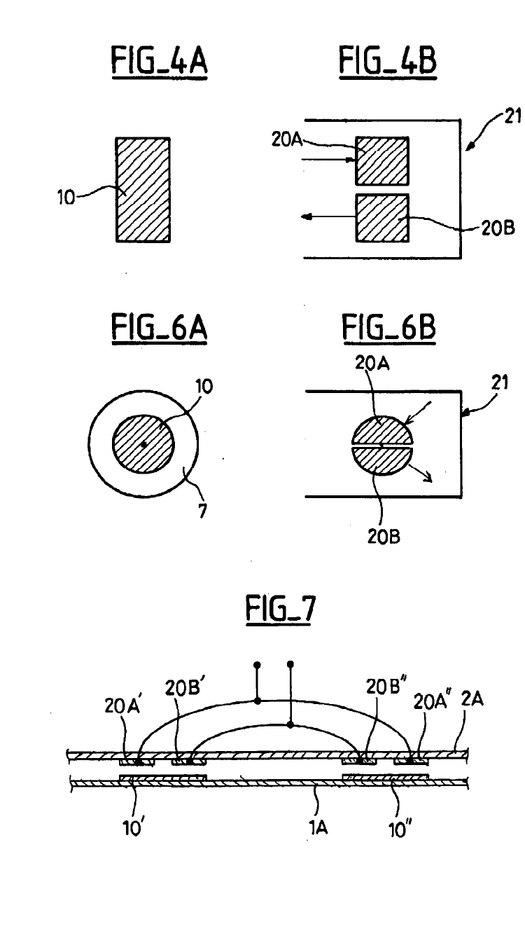

FIGS. 4A and 4B are a front view of a portion of the detection system and a front view of another portion of the detection system in a second embodiment.

FIG. 5 is a section view of a system for detecting positioning in accordance with the invention and constituting a second embodiment.

FIGS. 6A and 6B are a front view of a portion of the detection system and a front view of another portion of the detection system, in another embodiment.

FIG. 7 is a diagram showing a plurality of detection systems associated by being connected in parallel.

FIG. 1 is a diagram showing a fluid meter 1, more particularly a water meter, fitted with a measuring module 2 on its top face. The meter 1 comprises a vessel 4 provided with an inlet channel 5 and an outlet channel 6, and receiving measurement means such as a volume measuring chamber or a spinner system, together with a counter 3 for metering consumption.

The module 2 acts electronically to detect or identify rotary movement of a rotary part that turns with a speed of rotation that is proportional to consumption. Thereafter, this rotary movement can be processed or used and accumulated electronically, and the accumulated consumption together with other information can be transmitted over an optical or electronic communications system for billing, monitoring, or control purposes.

FIG. 2 shows part of the interface between the meter 1 and the module 2, with the wall 2A of the module being placed on the wall 1A of the meter, and more precisely of the counter.

The system for detecting the positioning of the remote measuring module 1 comprises a first electrically conductive element 10 fixed on a portion associated with the meter, in this case stuck on the inside face of its wall 1A, and two second electrically conductive elements 20A and 20B fixed to the module and placed facing the first element when the module 2 is properly disposed on the meter 1. These electrically conductive elements form a capacitive sensor.

The second elements 20A and 20B are electrically connected to an electronics card 21, and are preferably integrated in said electronics card.

Advantageously, the electrically conductive elements are constituted by metal coatings.

An embodiment of these electrically conductive elements is shown in FIGS. 3A and 3B.

The electrically conductive element 10 is an area of electrically conductive material, e.g. in the form of metallization. This area is in the form of a circular sector, and in the example shown it occupies 1800.

The area 10 co-operates with two electrically conductive elements 20A and 20B formed by two electrodes provided on the printed circuit card 21. The electrodes 20A and 20B are likewise in the form of circular sectors, with each of the electrodes in the embodiment shown occupying a circular sector of about 50°. In the embodiment shown, the electrode 20A serves as an excitation electrode and the electrode 20B as a receiver electrode, their operation being described in greater detail below.

When the module is properly positioned on the meter, the electrodes 20A and 20B and the electrically conductive element 10 face each other in full. A capacitor is thus constituted between the area 10 and each of the electrodes 20A and 20B. The area 10 provides capacitive coupling between the two electrodes 20A and 20B, such that when a voltage pulse is applied to the excitation electrode 20A which is capacitatively coupled, it is possible to read or pick up a corresponding reception signal from the receiver electrode 20B, with this signal corresponding to a threshold value and a “correct position” state.

If positioning is modified, the received signal is different from the preceding signal and an “incorrect positioning” state can be deduced therefrom.

Naturally, it is possible to position the electrically conductive elements differently and to select as the threshold value the capacitance which corresponds to any other relative positioning of the electrically conductive elements 10, 20A, and 20B.

FIGS. 4A and 4B show another embodiment presenting the advantage of being better optimized in terms of space occupied relative to signal received.

The electrically conductive element 10 is an area of electrically conductive material, e.g. in the form of metallization. This area 10 is in the shape of a rectangle and it co-operates with two electrically conductive elements 20A and 20B forming two electrodes on the printed circuit card 21. The electrodes 20A and 20B are likewise rectangular in shape. In the embodiment shown, the electrode 20A serves as an excitation electrode, and the electrode 20B as a receiver electrode.

When the module is properly placed on the meter, the electrodes 20A and 20B and the electrically conductive element 10 face each other in full.

Apart from their shape, this second embodiment operates in identical manner to the first embodiment described above.

The electronic processing means include, amongst other things, voltage producing means, amplifier means, and logic gates or microprocessor means, which are within the competence of the person skilled in the art and are not described in greater detail herein.

FIG. 5 shows a second embodiment.

The Figure shows a portion of the counter 3 of the meter. This portion comprises gearing enabling a moving consumption target 7 or indicator to be turned, which target is situated close to the wall 1A of the counter 3. This wall 1A may be transparent so as to enable the rotating target to be viewed, if necessary for reasons such as readability of an index mark or if useful in order to be able to detect that rotation is taking place.

The electrically conductive element 10 is placed on the face of the target that faces towards the wall 1A, and in the module, there are two electrically conductive elements 20A and 20B.

In this embodiment, the electrically conductive element 10 may also be used for detecting rotation of the target by means that are optical, capacitative, inductive, or magnetic, for example, in addition to performing its function of detecting positioning.

The electrically conductive elements 10, 20A, 20B are then shaped in such a manner as to face one another at least in part throughout the rotation of the target 7.

FIGS. 6A and 6B show a configuration suitable for this embodiment.

The electrically conductive element 10 is an area of electrically conductive material, e.g. in the form of metallization. This area 10 is in the shape of a circle centered on the axis of rotation of the target 7. It cooperates with two electrically conductive elements 20A and 20B formed by two electrodes provided on the printed circuit card 21. The electrodes 20A and 20B are in the form of semicircles. In the embodiment shown, the electrode 20A serves as an excitation electrode and the electrode 20B as a receiver electrode.

When the module is properly positioned on the meter, the electrodes 20A and 20B and the electrically conductive element 10 face one another in full.

Apart from their shape, the operation of this example is identical to that of the examples described above.

The system includes an alarm which is put into operation in the event of a change in the capacitance of the capacitor formed by the electrically conductive element.

The alarm may be put into operation whenever said capacitance departs from the threshold value or from a fixed range of values. The alarm may also be raised on the basis of differentiating the capacitance relative to time, where the time derivative should remain within a certain range. The notion of time is thus automatically included in taking the derivative.

The alarm system may be implemented in various ways.

When the measuring module 2 is installed, the operator may ensure that the module is properly positioned, with or without there being any flow of water. The capacitance sensor may be set immediately after the module has been put into position or after a determined time lapse.

During the lifetime of the system, the alarm may be saved and may be read next time consumption is remotely measured. Thus, the alarm may serve to detect removal, fraud, or attempted fraud.

The alarm may be constituted by the metering system stopping or by a light signal that is emitted continuously or intermittently and coming from the measuring module or from the fluid meter. The signal may be emitted while the module is being installed or while it is in use. A signal of a different color may serve to distinguish between the correct position and an incorrect position or an attempt at fraud.

A plurality of detection systems of the kind described above may be associated and connected in parallel in order to increase the detection area and thus the zone which is sensitive to lifting.

Such an association is shown diagrammatically in FIG. 7. Two conductive elements 10′ and 10″ are fixed to the wall 1A of the meter and they face respectively on the wall 2A two pairs of electrodes, with the excitation electrodes 20A′ and 20A″ being connected to each other and with the two receiver electrodes 20B′ and 20B″ being connected to each other. This arrangement is equivalent to two capacitors connected in parallel.

1. A system for detecting the positioning of a remote measuring module placed on a fluid meter, a first wall, associated with said module, being disposed close to a second wall associated with the meter, said system comprising:
at least a first electrically conductive element fixed to said second wall of said meter; and
at least two second electrically conductive elements fixed to said first wall of said module, and placed facing said first element when said module is correctly positioned on said meter, said second elements are connected electrically to an electronics card, one of said second elements being a voltage-emitter electrode and the other of said second elements being a voltage-receiver electrode.

2. A system according to claim 1, wherein said first element is fixed on said first wall of said meter on the inside thereof.

3. A system according to claim 1, wherein said meter includes a moving consumption indicator, such that said first element is fixed on the face of said indicator that faces towards said module.

4. A system according to claim 1, wherein said second elements are integrated in said electronics card.

5. A system according to claim 1, wherein said electrically conductive elements are metal coatings.

6. A system according to claim 1, further comprising an alarm put into operation in the event of any change in the capacitance of the capacitor formed by said electrically conductive elements.

7. A system according to claim 6, wherein said alarm is put into operation when the capacitance departs from a threshold value.

8. A system according to claim 6, wherein said alarm actuates a light signal.

9. A fluid meter, including a first electrically conductive element forming a portion of a position detecting system according to claim 1.

10. A detection module for co-operating with a fluid meter and including said second electrically conductive elements forming portions of a position detection system according to claim 1.
